(19) United States
(12) Patent Application Publication
(10) Pub. No.: US 2007/0127539 A1
(43) Pub. Date: Jun. 7, 2007

(54) Narrow band laser with wavelength stability

(75) Inventors: Weizhi Wang, San Jose, CA (US); Guangzhi Z. Zhang, San Jose, CA (US); Lam T. Le, Fremont, CA (US)

Correspondence Address: MORRISON & FOERSTER LLP, 425 MARKET STREET, SAN FRANCISCO, CA, 94105-2482, US

(73) Assignee: New Focus, Inc.

(21) Appl. No.: 11/238,337

(22) Filed: Sep. 28, 2005

(51) Int. Cl. H01S 3/08

(52) U.S. Cl. 372/101; 372/107

(57) ABSTRACT

An external cavity diode laser system includes a thin film filter. The output facet of the laser diode is coated with a partial reflection coating and the cavity side facet is coated with an anti-reflection coating. A roof-top prism or corner cube retroreflector serves as the laser cavity end reflector and provides stability of the wavelength of the output over time. The laser cavity lies between the partial reflective coated facet of the laser diode and retroreflector. A collimating lens and a thin film filter are located between the end reflector and the laser diode cavity side facet. The lasing wavelength can be adjusted during either manufacture or operation by tilting the filter. Also included is thermal compensation in the mounting for the retroreflector to compensate for thermal movement of the laser system cavity.

### FIELD OF THE INVENTION

This disclosure is directed to optical devices including external cavity semiconductor lasers and other type of lasers, and in particular, to external cavity lasers having stabilized nominally single wavelength (narrow band) outputs.

### BACKGROUND

External cavity semiconductor lasers are well known. See Scobey et al., U.S. Pat. No. 6,115,401, assigned to Corning OCA Corporation, incorporated by reference herein in its entirety. In external cavity diode lasers which are typical of such devices, an optical cavity extends between a first facet (surface) of a semiconductor diode laser (laser diode) and an external reflector, defining the laser cavity ends. The opposite facet of the semiconductor diode laser, between the diode laser and the first facet, typically carries a partial reflection coating to allow light to escape the diode laser with minimum reflection.

Such laser systems have been used extensively as transmitters for fiber-optic communications, for instance, in the telecommunications field. Use of these and other diode-type lasers has been impeded due to inadequate stability and accuracy in the particular light wavelengths generated. For instance, the wavelength band of light emitted by presently known semiconductor diode lasers varies to an unacceptably large degree with temperature and other factors. Presently known semiconductor lasers also suffer the disadvantage of poor manufacturing repeatability. That is, an intended or specified emission wavelength is not achieved with adequate accuracy when such lasers are produced in large commercial quantities.

In external cavity lasers the anti-reflection coating is formed on one facet of a diode laser chip. The emitted light is captured by a collimating lens, and a diffraction grating or filter acting in part as an external cavity reflector, is used to select or tune the output wavelength of the laser. Another type of external cavity laser incorporates a Fabry-Perot thin film interference filter in the external cavity. The thin film filter passband defines the resonant oscillation in the laser cavity and thus the operating output wavelength of the laser. Wavelength tuning is typically accomplished by tilting the filter relative to the axis of the incident light beam.

An example of same is shown in Svilans, U.S. Pat. No. 6,556,599, assigned to Bookham Technology and incorporated by reference herein in its entirety. In Svilans an external cavity laser has a light source unit, including a semiconductor light source having internal optical gain and a collimating lens, for supplying collimated light to a retroreflector via an angle-tuned filter extending across an optical axis of the light source. The retroreflector is positioned so as to receive light from the light source via the angle-tuned filter and reflect the light via the angle-tuned filter back to the light source. The retroreflector is, for instance, a quarter pitch graded-index (GRIN) lens having a proximal end surface oriented towards the light source and a distal end surface opposite thereto, with a mirror provided on the distal end surface, preferably as a high-reflectance coating.

Present FIG. 1 is identical to Svilans FIG. 1 and shows semiconductor light source 10 typically a laser diode, and angle-tuned filter 12 tilted relative to the optical axis OA. Filter 12 is typically a narrow band transmission filter with a −3 dB bandwidth from 0.1 nm to 10.0 nm wavelength, for example. There is also provided unitary retroreflector 14. First lens 16 focuses light for output from a rear facet 18 of light source 10 into optical fiber 20 on the output side. The light is also directed onto second lens 22 at the opposite end of light source 10 which collimates light from a front facet 24 of light source 10 and directs it through filter 12 with the light beam axis substantially parallel to optical axis OA. Anti-reflection coating 26 is provided on the front facet 24.

A tilting mechanism 28 of well known type tilts angle-tuned filter 12 mechanically about an axis T orthogonal to the optical axis OA so as to select different wavelengths for transmission to retroreflector 14 and thereby tune the output wavelength of the emitted light. Retroreflector 14 typically is a graded-index lens 30 having a proximal end surface 32 adjacent the angle-tuned filter 12 and a distal end surface 34 remote therefrom. A mirror 36 is provided at the distal end surface 36 of lens 30, as a high-reflectance coating.

Svilans indicates that the external cavity laser may be of the fixed-wavelength type whereby during manufacture the components of FIG. 1 are assembled. During the manufacturing while monitoring the frequency/wavelength of the light from the light source 10 using a suitable device (not shown) at the output 20, angle-tuned filter 12 is rotated by tuning mechanism 28 relative to optical axis OA to tune to a prescribed output wavelength. Angle-tuned filter 12 is then fixed at that tilt angle using any suitable means (not shown) such as cement, UV epoxy adhesive, etc. The tilting mechanism itself may then be removed as not necessary. This laser thereby may be a fixed-wavelength or tunable external cavity laser depending on whether or not the tuning mechanism 28 is present in the device as provided to users.

Zorabedian et al., U.S. Pat. No. 6,282,215, assigned to New Focus, Inc., incorporated herein by reference in its entirety also shows a tunable external cavity laser. This also includes a retroreflector 122 in his FIG. 1B. Zorabedian also shows the typical mounting (in his FIG. 1A) including a base or optical bench on which the various components are mounted including intervening mounting blocks 140 and 148, as conventional in the field.

Most external cavity diode lasers are of the tunable type in terms of the wavelength being variable by the user. As indicated above, fixed wavelength output external cavity diode lasers are also known. Most such diode lasers however have been found inadequate in that they cannot tolerate harsh environmental conditions while maintaining their performance in terms of wavelength stability over a period of, for instance, several years. Typically these lasers have defects such as large wavelength drift, abrupt changes in wavelength with a finite step side size called mode-hop, or are relatively large in size and complicated in terms of their wavelength tuning schemes, resulting in reduced reliability and increased cost. Mode-hopping is a well known effect which is undesirable and which it is caused, for instance, by the tiling of the filter which results in a change in the optical path distance through the filter which does not correspond to the rate of change of the light wavelength so that the tuned light wavelength values undesirably jump or hop by an amount corresponding to the adjacent mode spacing of the external cavity of the laser system. Thereby it is a well known goal to provide mode-hop free output.

### SUMMARY

In accordance with this disclosure there is provided an external cavity laser system intended for (but not limited to) output of a fixed single (narrow band) wavelength light beam. The laser system includes as the reflector a self-aligning retroreflector such as a roof-top prism retroreflector or corner-cube type retroreflector. These provide self-alignment of the retroreflector, thus making the laser cavity insensitive to cavity end mirror tilting. They also provide low cavity loss and relatively small cavity size making the laser advantageous over other types of laser systems in both total power consumption and high power operation at a single output wavelength.

Also provided is a thermal compensation aspect making the cavity length of the laser system insensitive to temperature variation and thereby providing more robust mode-hop free operation. This includes using retroreflector position movement by thermal expansion of its mounting material thereby fully employing the self-alignment feature of the retroreflector. This has been found to reduce critical tolerances and adjustments, thereby improving manufacturability and reducing cost.

Even for a fixed wavelength laser, mode-hop could occur if the cavity length experiences a change over an amount of a fraction of wavelength, which is usually only a few hundred nanometers. The cavity length change can result from material thermal expansion, attachment relaxation, environmental disturbance, etc. The present laser system makes the compact cavity possible and in addition to that, the thermal compensating cavity and components insensitive to environmental disturbance are employed to make the cavity more robust.

### BRIEF DESCRIPTION OF THE DRAWINGS

FIG. 1 shows a prior art external cavity laser.

FIG. 2 shows an external cavity laser system in accordance with this disclosure.

FIG. 3 shows graphically the relationship between laser diode gain, filter transmission profile and cavity modes of the FIG. 2 system.

FIG. 4 shows in an exploded view of a mounting system for the system of FIG. 2.

### DETAILED DESCRIPTION

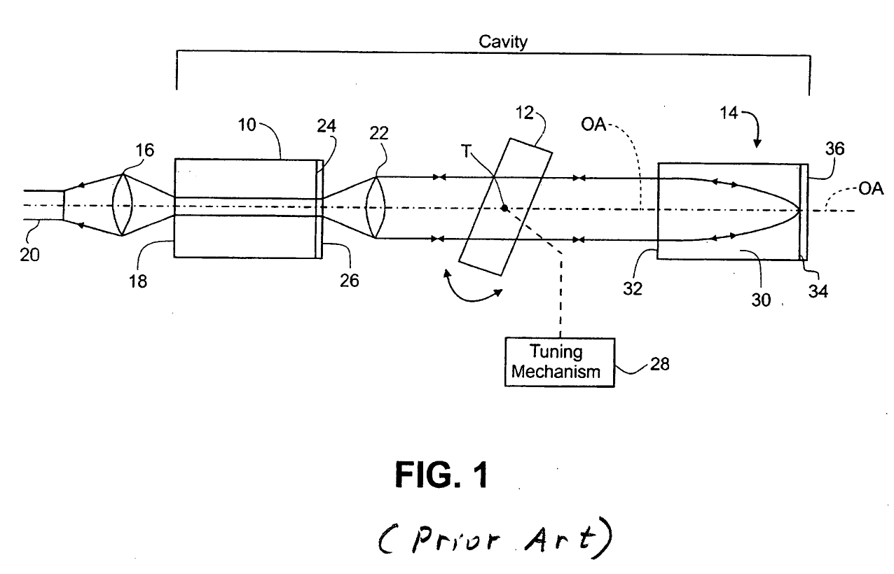

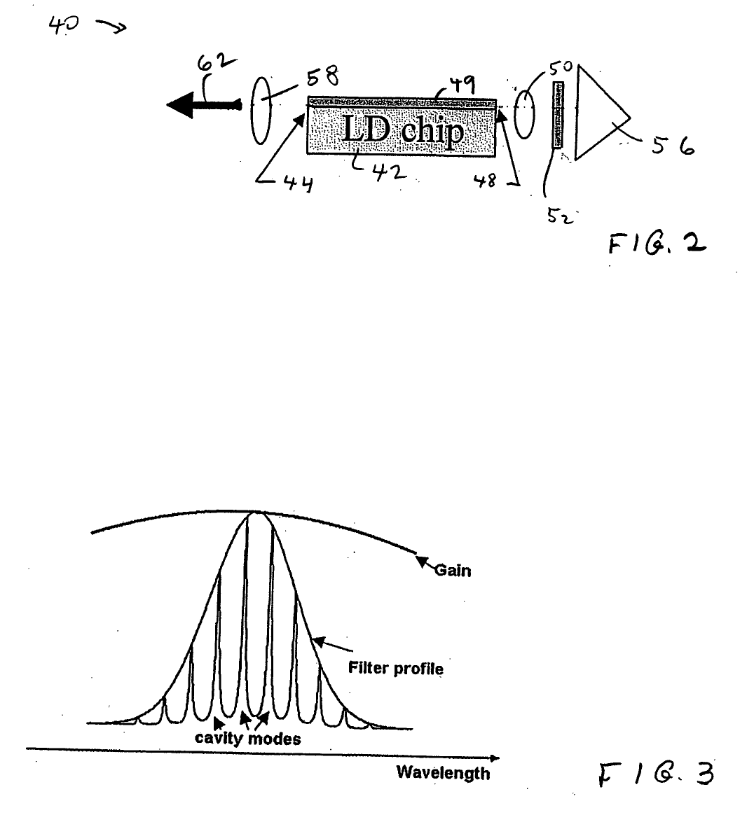

FIG. 2 shows in somewhat simplified form a laser system in accordance with this disclosure. It is to be understood that this is similar to FIG. 1 in the sense of omitting the associated mounting structures, power supply, etc. for simplicity of illustration. These are generally conventional, and of a type well known in the field. See, for instance, Zorabedian et al., U.S. Pat. No. 6,282,215, cited above, FIGS. 1A and 1B showing typical mounting systems. In some respects, the present mounting system is other than conventional, as further described below. FIG. 2 shows the external cavity diode-type laser. The laser diode (LD chip) 42 is conventional, for instance, part number SDL5400, purchased from JDS Uniphase. In one embodiment laser diode 42 outputs wavelengths of light in the range of 805 nm to 815 nm at output power of 0.2 watts. The power supply for laser diode 42 is conventional and not shown here. Such laser diodes are a type of solid state laser produced typically by semiconductor type manufacturing processes and are relatively small and inexpensive. While a laser diode is shown here, other types of lasers may be used as the source of coherent (laser) light and hence FIG. 2 is not limiting in this respect. Since such laser diodes are well known commercially available products, they are not discussed here in further detail.

Similarly the other components shown in FIG. 1 individually are of conventional type and commercially available. The laser diode 42 has two ends or facets or surfaces, the left-most one 44, in this case, carries a partial reflective coating and the right-hand facet 48 carries an anti-reflective coating both of the type well known in the laser diode field. The laser light emitted typically from the top surface 49 of laser diode 42 is incident on conventional collimating lens 50. For instance, such a lens is commercially available from Lightpath Technologies as part number 350330. Instead of a single collimating lens 50 there may be a lens system, that is several lenses in combination.

After being collimated by lens 50, the light beam is incident on thin film filter 52, of conventional type as disclosed above. As indicated above, thin film filter 52 during assembly of the laser system is typically subject to a certain amount of tilting in order to achieve the desired filter passband so that the filter passes only (nominally) a single wavelength of light (or a very narrow band of wavelengths). This tuning is conventional. In other embodiments this thin film filter may, in fact, not be fixed in place during manufacture, but is adjusted by a tuning mechanism of the type shown above to provide a tunable laser, whereby the user may adjust the output wavelength.

After passing through thin film filter 52, the light beam is incident on optical retroreflector 56. Retroreflector 56 is, for instance, a corner cube optical retroreflector of the type well known in the optical field. These are also known as “cube corners.” The main property of a corner cube reflector is that a light beam incident upon it is returned parallel to itself after three reflections. Thus a corner cube reflector is also called a retroreflector. The sides of the reflector are three interior sides of a cube each with a reflective surface. Hence any incident light returns parallel to the incident beam, but separated therefrom. Such optical devices are readily available commercially. For instance, in this case part number 02CCG from Melles Griot Company may be used. The advantage of corner cube reflectors is the actual angular orientation of the reflector is not critical in order to achieve the retroreflection. This is very useful in conjunction with the laser system of FIG. 2.

Another type of optical retroreflector suitable for use in the FIG. 2 system is a roof-top prism also commercially available. Again, this serves as effectively as a laser cavity end reflector. In either case, the laser cavity is considered to be that portion of the system located between the partial reflective coating 44 and the reflecting surface of the retroreflector 56. Both these types of retroreflector have the advantage of large angular deviation tolerance (self-aligning), wide working wavelength range, and being relatively inexpensive to manufacture or purchase. Note that such a roof-top prism reflector is not the same as the prism reflector in above cited Scobey et al., U.S. Pat. No. 6,115,401. Scobey uses an end reflector on a prism where the prism itself is not providing any reflective feature but serves other purposes. In the present case, the roof-top prism retroreflector is the prism itself using total internal reflection. It thereby has the advantage of the large angular deviation tolerance and is therefore relatively robust and more suitable for low cost manufacturing.

The advantage of these types of retroreflectors is that they are insensitive to tilting in the X and Y axis (the plane of the drawing of FIG. 2) and rotation about the Z axis (perpendicular to the plane of the drawing). Therefore, such devices are robust to environmental impacts when the laser system is in use. An example of a roof-top prism is the well known Amici prism. This is a right angle prism used as a reflector having a second right angle roof added to the hypotenuse. See, for instance, “Elements of Modern Optical Design,” Donald C. O'Shea, Wylie-Interscience Publication, John Wylie & Sons, 1985, pg. 133 and 134. The additional reflection surface in such a device provides an inversion in place of the reversal introduced by a simple reflector. The term “roof” here indicates there are two mirrors lying at right angles to one and other. This eliminates (or adds, depending on the definition) an image reversal in the optical train. Any retroreflector having the self-alignment would also be suitable. In general, in a prism type retroreflector the prism has, in cross-section, a right angle shape. The hypotenuse of the right triangle is the entrance and exit facet. The permanent alignment of the reflecting faces and the total internal reflections provide parallel retroreflection. Note that the main drawback of prism retroreflectors is their cost and weight since they are made of solid glass or similar material. If the cross-sectional area of the entrance or exit of the prism is greater than approximately 5 sq. cm, the weight of the prism becomes considerable as does the cost of fabricating such a prism. Hence, for a larger diameter cross-sections typically a mirror-type retroreflector such as the corner cube reflector becomes more economical.

In the case of the FIG. 2 laser system, thin film filter 52 instead of being an independent structure may be manufactured on the incident surface of the retroreflector 56. This enhances robustness and possibly reduces cost. This typically is especially useful when a precise laser output center wavelength is not required. Note that the output side collimating lens 58 may collimate the light output beam 62 for either free space transmissions or for focusing light beam 62 into an optical fiber (not shown) as well known in the field.

FIG. 3 shows graphically the relationship between laser diode gain, filter transmission profile, and cavity modes for the FIG. 2 laser system 40. The horizontal axis is wavelength and the vertical axis light amplitude. The filter profile (middle curve) describes the passband of filter 52 and the variations in the cavity modes show the hopping wavelength positions. The illustrated narrow wavelength passband is designed to align with the desired laser system operation wavelength. The transmission spectral profile (in effect here the passband for a transmission type filer) can be set in order to optimize the single frequency performance of the laser system of FIG. 2. The laser diode gain, as indicated by the cavity modes curve, is filtered by the filter profile. Amongst several cavity modes under the filter profile curve, the mode with the maximum gain will lase in laser diode chip 42. Laser system 40 thereby maintains its single mode operation in this mode until condition changes cause this to fail. Such condition changes include ambient effects such as temperature, the laser diode 42 drive electric current, and mechanical induced changes in the laser cavity length and other factors.

One aspect affecting the laser cavity length is temperature. Temperature variation causes thermal expansion of all types of materials which determine the cavity length. Since the laser diode semiconductor material of laser diode chip 42 has a relatively large refractive index dependent on temperature, the cavity thermal stability remains an issue for mode-hop free operation over the lifetime of the laser system 40. Therefore, in accordance with this disclosure, in order to minimize the cavity length dependence on temperature, a thermal compensation structure is introduced to the base for the cavity end reflector mounting. An advantage of this is to make full use of the insensitivity of the retroreflector to tilting, that is poor mechanical alignment.

Hence in accordance with this disclosure, the structure includes a base or support for the laser diode chip 42 where the base or support is made from material(s) with a low thermal expansion coefficient. An example of such material is Invar, a type of iron alloy with very low thermal expansion coefficient. In addition, the retroreflector 56 mount includes a material with a thermal expansion coefficient selected to compensate for laser cavity length changes due to the material expansion and contraction during thermal fluctuation.

Thus in one embodiment, a thermal compensating element is provided so that thermal expansion of the compensating element offsets difference in the expansion of the system base in order to maintain a substantially constant output wavelength within the laser cavity despite temperature variations. Thermal compensation is provided in Tuganov et al., U.S. Pat. No. 6,330,253, assigned to New Focus, Inc., incorporated herein by reference in its entirety, see FIG. 3. In Tuganov, the laser diode, the diffraction grating which serves as a filter and the retroreflector are laid out in a generally triangular arrangement, which can also be used in accordance with the present laser system. The Tuganov retroreflector is coupled to a thermal compensating element which in turn is coupled to a pivot bracket. The pivot bracket is coupled to the base at a pivot point which allows tuning of the laser by a combined rotation and translation of the retroreflector.

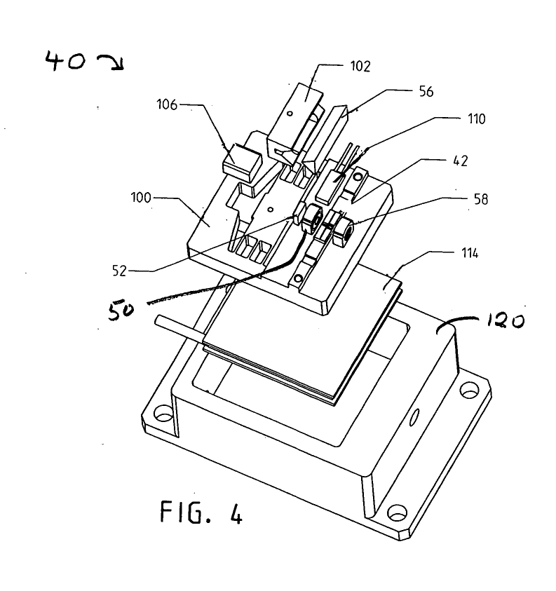

Since such tuning is not always necessary in accordance with the present laser system, this pivoting system may be dispensed with. Instead, here the thermal compensating element rather than being mechanically moveable on a pivot may be, for instance, a suitable material such as brass or aluminum which has large thermal expansion coefficient. Hence, present FIG. 4 (an exploded view) shows this thermal compensation element 106. Base 100 supports a mounting block 102 to which is mounted retroreflector 56 (here a prism) of FIG. 2. Base 100 also supports lenses 50, 58 and laser diode chip 42 and filter 52 of FIG. 2. Base 100 has flexure structures machined into it at the location where retroreflector support 102 is mounted. The flexures allow for parallel movement of retroreflector 56 on support 102 independent of base 100. Thermal compensating body 106 is inserted in base 100 having one end touching the flexures in base 100 and its other end in contact with the solid portion of base 100. During thermal cycling, thermal compensating body 106 expands or contracts thus moving retroreflector 56 on its support 102 to compensate for thermal contraction/expansion of the other cavity components. The assembly sits in mount 120.

The thermal compensation or athermal cavity configuration here thereby uses mechanical structure and material selection for components attachment such that the end cavity mirror, which is the retroreflector 56 in this case, is mounted on a structure that thermally moves opposite to the rest of the cavity components. The materials for thermal compensation can be selected by routine calculation of each thermal expansion contribution of the components including the base, and finalized by routine experimental optimization.

Retroreflector 56 here inherently has the self-alignment aspects making the reflector insensitive to tilting in the plane vertical to the cavity optical axis. This greatly enhances cavity stability and facilitates manufacturing of laser system 40. Due to compact design and rigid components, laser system 40 may have ultra-narrow line width, for instance, on the order 10⁻¹⁵ meter, corresponding to 100 kilohertz in frequency, variation between maximum and minimum output wavelength. Since filter 52 typically has a very low loss in its passband, the cavity loss is significantly reduced compared to such laser systems using gratings instead of filters. Thus use of the present thin film filter has the advantage of high cavity efficiency and hence is suitable for high power applications.

In certain embodiments, in order to achieve ultra-stable single wavelength light output, in addition to the above configuration of the laser cavity, the entire laser cavity is subject to temperature control. This provides a large margin to ensure that the mode-hop free operation over the lifetime of laser system 40 includes absolute temperature drift in the temperature control due to any aging of the temperature sensor or electronics components. FIG. 4 also shows the system for providing temperature control, which is a conventional thermal control loop. It includes a temperature sensor 110 electrically coupled to a processor (not shown) which receives a signal from sensor 110 indicating the temperature of the cavity of laser system 40. The processor outputs a signal to thermoelectric cooler/heater 114 in order to maintain a particular temperature of the laser cavity. A housing (not shown) may be provided around the components of FIGS. 2 and 4 for environmental protection. A housing will help to reduce the air circulation around the laser cavity and therefore help the laser stabilization, and a housing can be employed if necessary to shield other disturbing or destructive radiations or fields. The set point of the temperature control is in a wide range and is only limited by the working environment and components' heat capacity.

Modifications to the above configuration are contemplated in accordance with this disclosure. For instance, the retroreflector 56 roof-top prism may be an electro-optic crystal type making possible electrical fine tuning of the output light wavelength. A suitable crystal is lithium niobate, which can be purchased from, for example, Crystal Technology. It is also possible to use a PZT (piezoelectric) actuator mounted retroreflector. Piezoelectric is a well known type of actuator using a ceramic material PZT which expands/contracts with applied electrical signals. PZT stands for Lead Zirconate Titanate which is a high dielectric constant material suitable for use in such actuators.

Here we address the possibility of tuning the laser by changing its cavity length, opposite to an athermal design. Of course, these cavity length control approaches can be also employed for compensation of the cavity length drift, however, in a more complicated manner.

In other embodiments, the thin film filter may be replaced with an etalon or other types of wavelength dispersing devices. An etalon is a well known optical component, which includes a pair of plane parallel optical interfaces or reflectors of constant separation whereby interference occurs between beams of light that are multiply reflected between the two interfaces or reflectors. In this disclosure when a “filter” is referred to it is understood that generally this refers to other filtering devices including, for instance, an etalon used in the filtering mode. Hence, an etalon may be substituted for filter 52 in FIG. 2.

This disclosure is illustrative and not limiting; further modifications will be apparent to those skilled in the art in light of this disclosure and are intended to fall within the scope of the appended claims.

What is claimed as new and desired to be protected by Letters Patent of the United States is:

1. A laser system comprising:
a source of coherent light having two opposing surfaces;
a first lens adjacent a first surface of the source of light;
a filter adjacent the first lens;
a self aligning retroreflector adjacent the filter; and
a second lens adjacent the opposing surface of the source of light.

2. The laser system of claim 1, wherein the source of light is a laser diode.

3. The laser system of claim 1, wherein the filter is a thin film filter or etalon.

4. The laser system of claim 1, wherein the lenses are each collimating lenses.

5. The laser system of claim 1, wherein the retroreflector is a roof-top prism or a corner cube.

6. The laser system of claim 1, wherein a plane defined by a surface of the filter lies at an angle other than 90° to an axis of a light beam emitted from the light source and incident on the filter.

7. The laser system of claim 1, further comprising an anti-reflection coating on the first surface and a partially reflecting coating on the opposing surface.

8. The laser system of claim 1, further comprising a support for the lenses, the source of light, the filter, and the retroreflector, wherein the retroreflector is mounted to the support with a thermal compensation element.

9. The laser system of claim 8, wherein the retroreflector is on a support, and the thermal compensation element is a body in contact with the base and the retroreflector support.

10. The laser system of claim 1, further comprising a thermal control associated with the laser system.

11. A method of operating a laser system having a source of coherent light, comprising the acts of:
collimating the coherent light emitted from a first surface of the source;
filtering the collimated light;
reflecting the filtered light from a self aligning retroreflector, thereby reflecting the light back to the source; and
outputting the reflected light from an opposing surface of the source.

12. The method of claim 11, wherein the source is a laser diode.

13. The method of claim 11, wherein the filtering is by a thin film filter or etalon.

14. The method of claim 11, further comprising collimating the light again.

15. The method of claim 13, wherein the filter is tilted relative to an axis of the incident light.

16. The method of claim 11, further comprising the act of compensating for thermal movement of a cavity of the laser.

17. The method of claim 16, wherein the compensating includes:
providing a thermal compensating body in contact with a support for the retroreflector.

18. The method of claim 11, further comprising the act of controlling a temperature of the laser system.

19. The method of claim 11, wherein the retroreflector is a roof-top prism or corner cube.
